(19) United States
(12) Patent Application Publication
(10) Pub. No.: US 2011/0298751 A1
(43) Pub. Date: Dec. 8, 2011

(54) Multi-User Interactive Coffee Table

(76) Inventor: David Merel, New York, NY (US)

(21) Appl. No.: 12/795,624

(22) Filed: Jun. 7, 2010

(51) Int. Cl. G06F 3/042; G02F 1/1333; G02F 1/1335

(52) U.S. Cl. 345/175; 349/64; 349/58

(57) ABSTRACT

My invention is a Multi-User Interactive Coffee Table, which allows multiple users to interact with an LCD screen at the same time, using their fingers to manipulate virtual objects. In addition to multi user, the table supports object recognition, recognizing objects placed on the table and interacting with them. The table is a self-contained unit that combines hardware and software, including a multi user monitor and computer. Going far beyond the standard single-touch and initial attempts at multi-user interactivity, the Multi-User Interactive Coffee Table allows up to 20 users to interact separately and at the same time with the table. In addition, the table supports object recognition, interacting at the same time with different objects placed at separate parts of the table, and is made using LCD screens and LED lights which greatly increase the life of the table and eliminate the need for difficult bulb changes.

My Multi-User Interactive Coffee Table allows multiple users to interact with an LCD screen at the same time, using their fingers to manipulate virtual objects. In addition to multi user, the table supports object recognition, recognizing objects placed on the table and interacting with them. The table is a self-contained unit that combines hardware and software, including a multi user monitor and computer. Going beyond the old single touch screen and standard multi user deployment, the our table provides an infinite number of solutions for businesses of all sizes, and in many different industries.

Inside of the table, you will find a mounted computer, with its own motherboard, CPU, Ram, Hard drive and its own power supplies. A VGA cable is used to link the motherboard to the LCD matrix panel. The LCD matrix panel is essentially where the “image” is, however without the backlights, you won't be able to see anything, and we use 4 linkable LED lighting strips (each LED is 1 W) to light up the LCD panel. By using a reflective silver surface, lights get reflected internally to make it evenly lit given the bases triangular shape.

This is essentially a Windows 7 based computer inside a table base, however the system is operating agnostic given the software is designed using Adobe Flash/AIR which can run on Linux, MAC or Windows. It is topped with a 32-inch touch screen in a nice frame. A camera that can sense nearby objects is mounted beneath the screen in the dead center.

A power strip is used for providing power source to all components, including the computer, video controller, IR LED and the backlights. The power strip is connected with a power entry module that is connected to outside power source. A safety switch can turn on and off the power of the table.

The Top Acrylic is floated with IR (infrared) light from LEDs (Light Emitting Diodes) in a nonhuman-visible wavelength spectrum of about 850 nm. As the camera that captures the plate from beneath has its IR filter removed camera, that blocks visible light, it only ‘sees’ the points where the light leaves the plate (and not any other visible stuff like a projected image on the same surface). With imaging techniques, namely blob-detection, these light spots are identified and tracked. Normally, the plate is also used as the projection surface for the application. Pressures can give a direct visual feedback on the plate, but of course this is not mandatory. The multi touch detection is established by flooding IR light through the edges of the Acrylic material. The Acrylic itself must contain embedded diffuser particles which highly reflects and intensifies the infra-red light and produces a 91.0% Transmission rate.

By placing the IR LED lights around this special plastic with 850 nm wavelength and ensuring the LED's contain a 120 degree viewing angle, the IR lights completely illuminates the entire plastic. This creates an Infra-Red aura effect in and above the plastic. Pressing down or placing an object upon the plastic pushes away the lighting and leaving an outline to be detected by an Infra-Red camera (modified to view light only in the 850 mw wavelength) positioned below the plastic. The IR camera below sees the entire plastic flooded with light, the lack of light produces an ID, this ID is then translated into an X/Y coordinate and communicated to the software.

The LED lights themselves have been custom modified using super thin flexible PCB which allows perfect molding around the four corners of the plastic. In order to create an increased illumination of the surface the LED's a tightly packed together with less than half an inch between each LED (approx. 0.47 inches) and the viewing angle of each LED is 120 degrees to provide increased edge lighting. Also by using a 8 mm L grade Endlighten piece as opposed to the XL version there is an even higher concentration of diffuser particles.

The supporting channels stabilize all these layers including LCD matrix, Acrylic, End-Lightened acrylic and diffuser sheet in place.

The maintenance door can be opened for diagnostic and maintenance; also it enables to open the top portion latch to remove the top panel completely. A media slot is also embedded into the door allowing media to be uploaded into the table.

The table is uniquely designed as modular solution to enhance technical support issues. The base can unlatch from the frame allowing for easier distribution and replacement parts if the need arises. The top frame is comprised of a sandwich of interlocking pieces. The top piece which is the enhanced acrylic is sealed to the frame with silicon to achieve waterproof capability. Around the acrylic exists an aluminum channel which allows for easy installation of the IR LED lights. Beyond this layer exists the frame which encompasses the LCD matrix.

Additionally, the drawings that I am submitting contain the following:

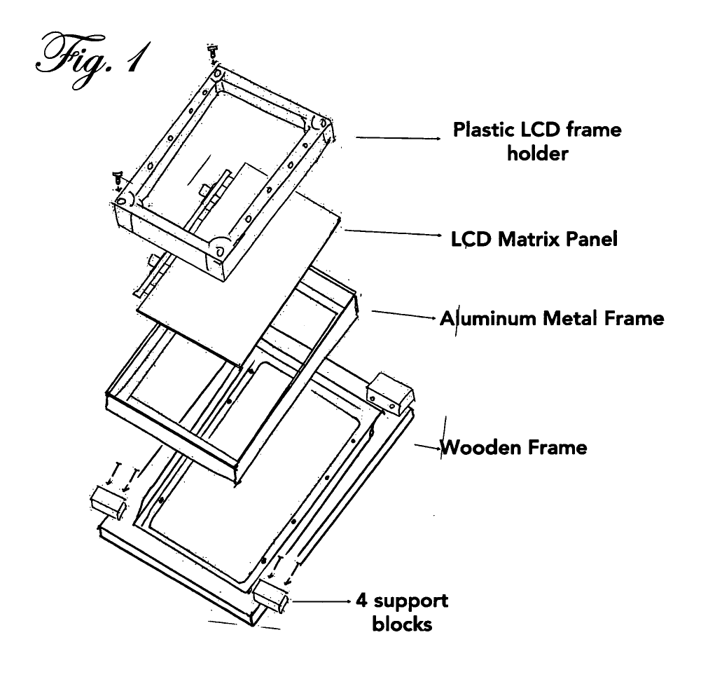

FIG. 1.

FIG. 1. describes the layering of the Multi-Touch screen as well as the interlocking components of the top frame of the table. Housed below the Frame contains the an Aluminum metal frame which when removed houses the IR LED strip which provides infrared lighting to the top diffuser-rich plastic. Directly below these pieces contains the layers to display the picture itself. The LCD needs to be separated from the backlight; therefore the frame contains only the LCD Matrix and the plastic frame which holds both the matrix and the diffuser directly below. The diffuser is used to evenly distribute light across the LCD matrix.

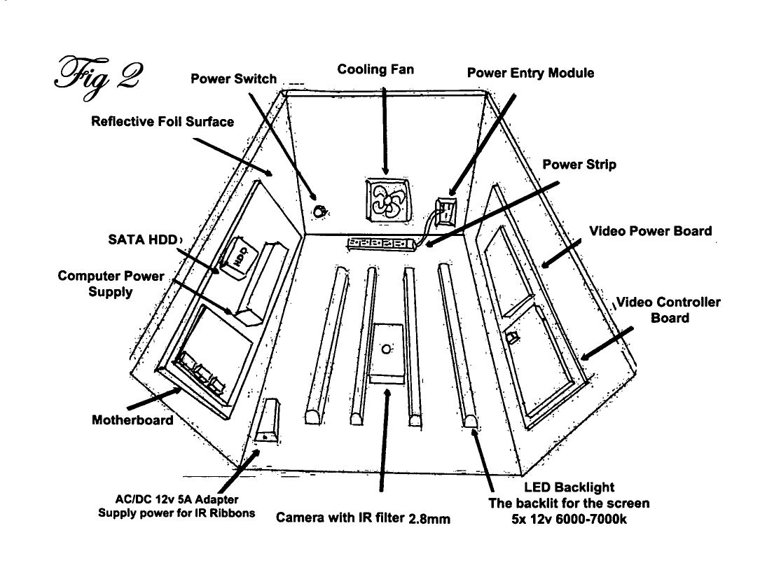

FIG. 2.

FIG. 2. describes the layout of the table's base. The base contains most of the components such as the computer (motherboard, hard drive, CPU, and memory), LCD components such as power board and video board, A modified camera which is positioned in the center of the base to pick up only infrared light. The LED strips are mounted parallel to the camera, these strips provide actual visible bright light to light up the LCD matrix above (located in the top frame in FIG. 1). The figure also illustrates the curved nature of the table in which reflective foil is lined throughout the entire interior of the base. This is done to reflect the light produced by the LED strips and evenly light the LCD matrix.

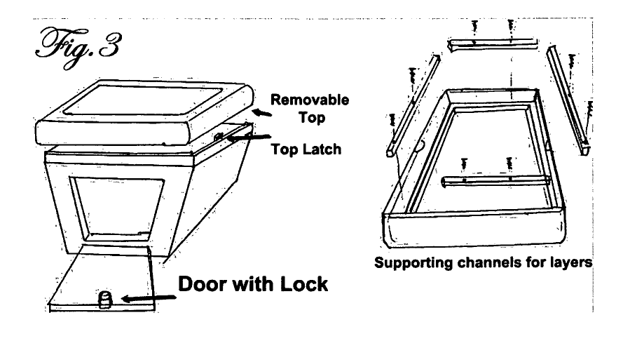

FIG. 3.

FIG. 3. describes in further detail the interlocking mechanism, the top frame has layers of interlocking pieces which release the matrix, IR led strips, diffuser and housing bracket for the LCD. Separately the diagram illustrates how the frame can be separated from the base which can be used for easier shipment or replacement parts. There is also an access door which can be used by a technician for maintenance without having to remove the entire frame.

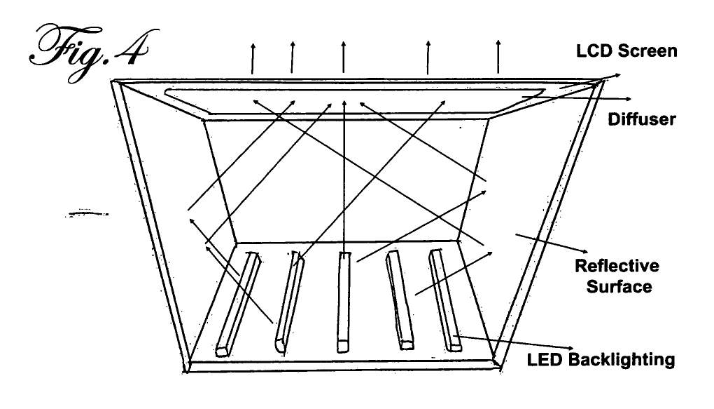

FIG. 4.

FIG. 4. illustrates how the reflective foil takes the visible light produced by the LED strips and bounces the light off the curved inner walls to bounce back towards the LCD matrix. This process creates an even illumination of the LCD matrix and provides a sharp and bright image.

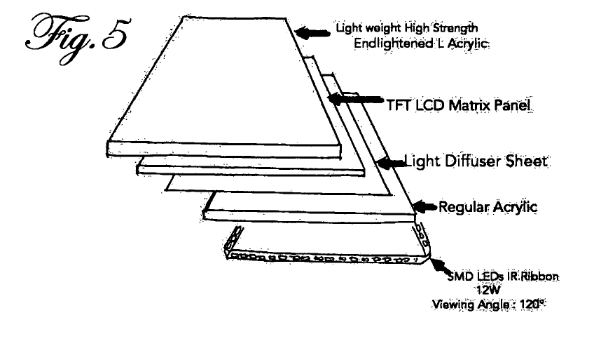

FIG. 5.

FIG. 5. illustrates the layers which produce the multi-touch technology. The top piece which is the particle rich plastic is housed around a strip of IR LED lights. This piece then rests on top of the LCD Matrix which produces the image. The diffuser below the matrix provides for even distribution of light across the matrix. The light is bounced evenly across the diffuser as illustrated in FIG. 4. The light originates from the LED strips which is illustrated from FIG. 2. The touches placed on the plastic surface are picked up and interpreted via the computer which is connected to the modified IR camera also illustrated in FIG. 2.

### BACKGROUND OF THE INVENTION

My invention is a Multi-User Interactive Coffee Table, which allows multiple users to interact with an LCD screen at the same time, using their fingers to manipulate virtual objects. In addition to multi user, the table supports object recognition, recognizing objects placed on the table and interacting with them. The table is a self-contained unit that combines hardware and software, including a multi user monitor and computer. Going beyond the old single touch screen and standard multi user deployment, the table provides an infinite number of solutions for businesses of all sizes, and in many different industries. The table is intended to take the place of a standard table for use in corporate waiting rooms, restaurants, bars, schools and universities.

What I am claiming is:

1. Lock & load Assembly (Figure C):
A coffee table with a unique locking and part loading mechanism which allows for a smoother and efficient assembly, transportation and servicing; a top frame with a sandwich of interlocking layers; a top most layer closer to the surface surrounded by removable aluminum channels which when removed expose a thin channel wrapping around the parameter of the plastic used for the touch recognition; ribbon IR led lights easily inserted within the groove of the channel without requiring any permanent paste such as glue or silicon; aluminum channels that once inserted are placed on top of it to both seal in the IR LED ribbon as well as to provide a platform for the next layer to rest upon; a second layer consisting of the LCD matrix, containing a frame to house and lock in the LCD matrix in a unique design since it holds only the matrix of the LCD without the backlight in place; a frame compatible with any standard LCD matrix aluminum frame and that can be comprised of either plastic or wood, which rests upon the aluminum channel and four mounting blocks are screwed into each of the four corners of the frame to hold in the last layer of the sandwich; a groove also made on two corners of the frame to allow a pass-through for a power cord which will power the IR LED lights; table frames that are detachable from the base for easier shipping, disassembly or repair; a frame locked into the base by clamps located on the inside of the frame; and access to the locks available through the maintenance hatch located on the base.

2. Touch Recognition (Figure A, B, E):
Recognition of the touch events accomplished by flooding a special transparent plastic which contains embedded diffuser particles with IR (infrared) light from LEDs (Light Emitting Diodes) in a non-human-visible wavelength spectrum of about 850 nm; a camera that captures the plate from beneath has its IR filter removed camera, which blocks visible light, ‘seeing’ only the points where the light leaves the plate (and not any other visible stuff like a projected image on the same surface); an imaging techniques, namely blob-detection, wherein these light spots are identified and tracked; the same plate also used as the projection surface for the application; touch detection established by flooding IR light through the edges of the plastic material; transparent plastic itself must containing embedded diffuser particles at a high concentration which requires an 8 mm thickness; concentration of these particles that highly reflects and intensifies the infra-red light and produces a 91.0% Transmission rate; LED lights themselves that have been custom modified using super thin flexible PCB which allows perfect molding around the four corners of the plastic; LED's tightly packed together with less than half an inch between each LED (approx. 0.47 inches) and the viewing angle of each LED is 120 degrees to provide increased edge lighting in order to create an increased illumination of the surface; IR LED lights placed around this special plastic with 850 nm wavelength and ensuring the LED's contain a 120 degree viewing angle so that the IR lights completely illuminates the entire plastic, creating an Infra-Red aura effect in and above the plastic; a situation wherein pressing down or placing an object upon the plastic pushes away the lighting and leaving an outline to be detected by an Infra-Red camera (modified to view light only in the 850 mw wavelength) positioned below the plastic; the IR camera below that sees the entire plastic flooded with light, the lack of light produces an ID, this ID is then translated into an X/Y coordinate and communicated to the software.

3. Separation and Backlighting Technique for the LCD (Figure A, B):
An LCD must be modified such that the backlight (usually containing a panel of compact florescent tubes and inverter board) is removed leaving only the LCD matrix in order to achieve object recognition and touch recognition with using an LCD; our own backlight mechanism which has a separation of at least 12 to 20 inches of distance from the LCD Matrix; the backlight placed on the bottom of the base comprised of 5 high powered 12 W 6000-7000 k pure white LED strips, each strip containing 12 LED lights of 1 W each with a life span of 50000 hours each for product longevity which produce enough light to light up the Matrix panel above; a diffuser placed directly below the LCD and placed inside the aluminum frame in which the LCD matrix rests upon in order to obtain a clear image and even distribution of light across the LCD matrix.

4. Reflection technique due to curvature design (Figure D):
A highly reflective foil tape lining the entire inside of the base in order to accurately and evenly distribute the light from our custom backlight solution to the matrix which allows the light to reflect off the curved sides and up to all portions of the LCD matrix; reflective foil allowing the table to have a curvature design.
